(19) United States
(12) Patent Application Publication
(10) Pub. No.: US 2006/0114325 A1
(43) Pub. Date: Jun. 1, 2006

(54) System and method to locate terrorists and criminals

(76) Inventor: David Russel von Hausen, Fairfax, VA (US)

Correspondence Address: David R. von Hausen, 5235 Stonington Drive, Fairfax, VA, 22032, US

(21) Appl. No.: 10/998,598

(22) Filed: Nov. 30, 2004

(51) Int. Cl. H04N 7/18; H04N 5/225; H04N 9/47

(52) U.S. Cl. 348/144; 348/169

(57) ABSTRACT

A system and methods to determine the point of origin of a moveable unit of interest, such as a car bomb in a large geographic area such as Bagdad. The system comprises of a high-flying platform such as an aircraft or satellite with the capability to obtain imagery of vehicles on the ground. The imagery is periodically transmitted to a ground unit with a receiver and indexed and stored on a storage device attached to a computer system with a display. When a terrorist event occurs on the ground such as a car bomb explosion, the system will provide a human operator the capability to track the initial location (building or home) where the vehicle departed before the event of interest occurs.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates, in general, to a criminal tracking system, and, in particular, to a criminal tracking system which provides information relating to the point of departure by terrorist or criminals before committing terrorist or criminal activity.

### DESCRIPTION OF PRIOR ART

As discussed in commonly assigned U.S. Pat. No. 6,757,008, to Steven Smith, video surveillance system provides high-resolution imaging over an area of interest but doesn't provide a system and method to track moveable objects.

As discussed in commonly assigned U.S. Pat. No. 6,522,250, to Ernst et al, filtering system where the moveable unit is integrated into the system itself providing one of location, direction, and time and does not track the moveable unit back to the point of departure.

What is needed is a system and methods that track terrorist and criminals to locations that may provide information as to their identities or whereabouts.

### BRIEF SUMMARY OF THE INVENTION

Terrorist use car bombs and improvised explosive devices (IED) to commit crimes. The identities of these individuals are often difficult to ascertain because they operate in secrecy striking targets with little or no warning. A number of crimes or terrorist acts consists of one or more individuals departing from a home or building, travel to a crime scene by car or on foot, and commits a crime. These crimes are often done outdoors and are detectable on high-resolution imagery taken from high-flying platforms or earth orbiting satellites. Technologies have evolved to the point where high-resolution images of events on the ground over wide areas can be captured frequently enough over long periods of time to provide a historical record of events on the ground. These images can be transmitted or transferred to a ground unit and analyzed using methods describe herein to track perpetrators of criminal acts back to the point of departure such as a building or home from which they originated before the crime took place. This information can then be disseminated to appropriate authorities.

In the drawings, which form a part of this specification,

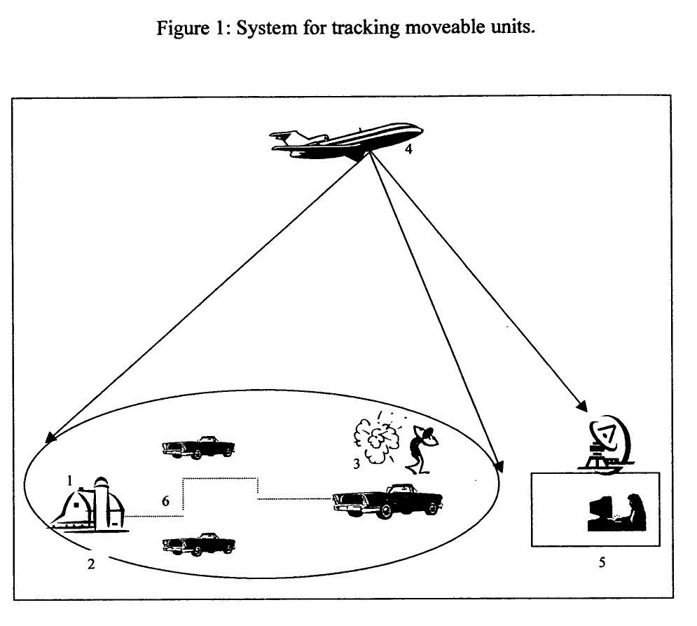

FIG. 1 is a view of the major components of the system according to the preferred embodiment of the invention.

### DETAILED DESCRIPTION OF THE INVENTION

A preferred embodiment and method according to the invention will now be described by way of example only with reference to the accompanying drawing identified above.

FIG. 1 illustrates an aircraft, object 4, at high altitude with an imaging device that captures images from a sensor with a average resolution of at least 4 meters per pixel. The said imaging device creates images of the region of interest such as a town or city identified by the ellipse, object 2. The images are captured at a rate of at least one every 8 seconds to provide sufficient information to track the movement of a specific moveable unit, object 3, on the ground and distinguish it from other moveable units on the ground. The images are transmitted to a ground unit, object 5, and indexed by time and stored on a storage device attached to a processor. A human operator controls the displays of the images on the said storage device to identify a subset of images that capture the event of interest. From these images, the operator can identify the moveable unit such as a person or vehicle. The operator tracks the history of movement of the moveable unit, object 6, using the methods claimed herein to the point of departure which is a home, building, or other structure that can be used to identify or locate individuals responsible for the event of interest. This information is then disseminated to authorities.

The said processor indexes and stores said images on the said storage device indexed in such a way as to allow the images to be displayed on the said display in the forward or reverse order in which the images were captured on the said imaging device. A human operator controls the display of images stored on the said storage device. The said operator visually identifies and tracks the said moveable unit of interest starting with one of the images containing the said event of interest. The operator controls the order and rate in which the images are displayed to track the history of movement of the moveable unit of interest until the point of departure of the moveable unit from a building, home, or some other recognizable location of value is identified. The operator may then disseminate the location to others that may have interest in the point of departure of the moveable unit.

In accordance to the preferred embodiment the invention provide the point of departure of a car bomb before detonation.

In accordance to the preferred embodiment the invention provide the point of departure of a vehicle used to transport terrorists planting an IED (Improvised Explosive Device) before detonation.

In accordance to the preferred embodiment the invention provide the point of departure of a vehicle or individual involved in a crime of bank robbery, murder, or kidnapping.

In accordance to an embodiment the invention provide the platform with sufficient storage capacity to store said images from said imaging device during daylight hours and physically transfer said storage device to said ground unit for processing at night.

I claim:

1. A system for capturing and processing images of moveable objects on the ground, the system comprises of:
A region of interest comprising of a town, city, or country where events of interest occur;
A high-flying platform such as an aircraft or satellite comprising of:
An wide-area image capturing device on the said high-flying platform that captures images of the said region of interest at a rate of at least one image every 8 seconds with an average image resolution of at least 4 meters per pixel;
A transmitter on the said platform to transmits said images of said region of interest;
A ground unit comprises of:
A receiver to receive said images from the said platform;
A storage device to store said images transmitted from the said platform;
A processor attached to the said storage device;
A display attached to the said processor for displaying said images capture from the said platform.

2. A system as claimed in claim 1 wherein said images are stored on a storage device on the high-flying platform and physically transferred to the ground unit removing the requirement to transmit the images using a transmitter on the platform and a receiver on the ground unit.

3. A system as claimed in claim 1 where multiple platforms are used to capture multiple images that are later combined to form images with sufficient coverage to track moveable units to their point of departure.

4. A system as claimed in claim 1 wherein the said region of interest is a country, city, or town.

5. A system as claimed in claim 1 wherein the moveable unit is tracked after the event of interest occurs to a location of interest identified as the point of return.

6. A method for tracking the said moveable unit to a location of interest, comprises of:
A method for identifying the moveable unit of interest, comprising of steps:
obtain approximate time and location when the said event of interest occurred;
identify by a human operator on said display the approximate location on one of the said images where the event of interest occurred;
display said images on said display in a sequence going forward or backward in time that allows the human operator to identify the said moveable unit of interest;
A method for tracking the moveable unit of interest, comprising of the steps:
A sequential display of said images backward in time to track the said moveable unit of interest until the its point of departure is identified;
An operator controlled sequential display of said images forward and backward in time to assure correct tracking of the moveable unit of interest.
